(19) United States
(12) Patent Application Publication
(10) Pub. No.: US 2007/0243904 A1
(43) Pub. Date: Oct. 18, 2007

(54) Customized wallpaper to called party mobile terminal

(76) Inventors: Frances M. Chin, Naperville, IL (US); Peggy Hasan, Aurora, IL (US); Huixian Song, Naperville, IL (US); Sandra L. True, St. Charles, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/403,362

(22) Filed: Apr. 13, 2006

(51) Int. Cl. H04B 1/38; H04M 1/00

(52) U.S. Cl. 455/566; 455/414.1; 709/223

(57) ABSTRACT

An apparatus in one example has: an incoming call mobile switching center that receives incoming calls; a home location register that stores routing information; a serving mobile switching center that stores mobile subscriber status, location, and routing information and that supplies a temporary location directory number, the home location register operatively coupled to the incoming call mobile switching center and to the serving mobile switching center; a customized wallpaper server operatively coupled to a wallpaper database, the wallpaper database having a plurality of stored wallpapers with corresponding assigned temporary location directory numbers, the customized wallpaper server operatively coupled to the incoming call mobile switching center and to the serving mobile switching center; and a customized wallpaper processor in the serving mobile switching center, the customized wallpaper processor processing a respective wallpaper for display on a display of a mobile terminal; wherein a respective wallpaper is displayed on a display of a mobile terminal when a respective temporary location directory number is rung at the mobile terminal.

### TECHNICAL FIELD

The invention relates generally to telecommunication systems and, more specifically, to a system that provides for customized wallpaper to be displayed on a called party's mobile phone.

### BACKGROUND

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

It is well known that cell phones, for example, may display the number and other information regarding an incoming call. This is commonly referred to as caller ID. However, users are quicker to identify a caller if an image of the caller or some other associated visual image is also displayed on the cell phone for an incoming call. Also, it may be more pleasing and entertaining for the user, especially if the user can choose the image. Unfortunately, an efficient means of accomplishing this is not available in the art.

Thus, there is a need in the art for a system that provides for customized wallpaper to be displayed on a called party's mobile phone.

### SUMMARY

One implementation of the present method and apparatus encompasses an apparatus. The apparatus may comprise: an incoming call mobile switching center that receives incoming calls; a home location register that stores routing information; a serving mobile switching center that stores mobile subscriber status, location, and routing information and that supplies a temporary location directory number, the home location register operatively coupled to the incoming call mobile switching center and to the serving mobile switching center; a customized wallpaper server operatively coupled to a wallpaper database, the wallpaper database having a plurality of stored wallpapers with corresponding assigned temporary location directory numbers, the customized wallpaper server operatively coupled to the incoming call mobile switching center and to the serving mobile switching center; and a customized wallpaper processor in the serving mobile switching center, the customized wallpaper processor processing a respective wallpaper for display on a display of a mobile terminal; wherein a respective wallpaper is displayed on a display of a mobile terminal when a respective temporary location directory number is rung at the mobile terminal.

Another implementation of the present method and apparatus encompasses a method. The method may comprise: an incoming call arriving to an in-call mobile switching center; the in-call mobile switching center sending a location request query message to a home location register to obtain routing information; if a mobile terminal has subscribed to service, the home location register sending a request to a serving mobile switching center for status, location and routing information of the mobile terminal; the serving mobile switching center sending back the routing information of the mobile terminal, and a temporary location directory number to the home location register; the home location register checking whether the mobile terminal has customized wallpaper service; if the mobile terminal has customized wallpaper service, the home location register adding a prefix to the routing information (temporary location directory number) of the customized wallpaper server and sending the prefix+temporary location directory number and calling party number to the in-call mobile switching center; the in-call mobile switching center receiving the routing information from the home location register, removing the prefix, and routing the call to the customized wallpaper server based on the prefix with calling party number, original called party number and temporary location directory number passed to the customized wallpaper server; the customized wallpaper server recognizing that the incoming call is for a customized wallpaper user and checking a database for the customized wallpaper user with the calling party number; the customized wallpaper server identifying which predefined wallpaper is to be displayed and routing the call to the customized wallpaper user's serving mobile switching center, the identified predefined wallpaper image based on the temporary location directory number; a customized wallpaper processor in the serving mobile switching center receiving and processing the identified predefined wallpaper image; the serving mobile switching center paging and alerting the mobile terminal with received wallpaper image; and the mobile terminal displaying the wallpaper image.

### DESCRIPTION OF THE DRAWINGS

Features of exemplary implementations of the invention will become apparent from the description, the claims, and the accompanying drawings in which:

FIG. 1 is a representation of one implementation of an apparatus that provides a customized wallpaper to be displayed on a called party's mobile phone for incoming callers;

FIG. 2 is a representation of another implementation of an apparatus that provides a customized wallpaper to be displayed on a called party's mobile phone for incoming callers; and

FIG. 3 is a representation of one exemplary flow diagram according to the present method for customized wallpaper to be displayed on a called party's mobile phone for incoming callers.

### DETAILED DESCRIPTION

Wallpaper is a piece of content that is installed on mobile phones. That is, a wallpaper is simply a graphic that is formatted to fit the screen of hand held devices, mainly cell phones. The placement of wallpaper images on the background serves to provide a decorative touch to the overall mobile phone display, and gives the user the opportunity to personalize the display of his or her mobile phones. Wallpaper images are usually included as part of the mobile phone operating system, or are added later by the user with the addition of a designated wallpaper program or other software, or by downloading images from various sources on the Internet, such as web pages, commercial sites, or the like. Often wallpaper images are acquired based upon a particular user's personal interests or pursuits.

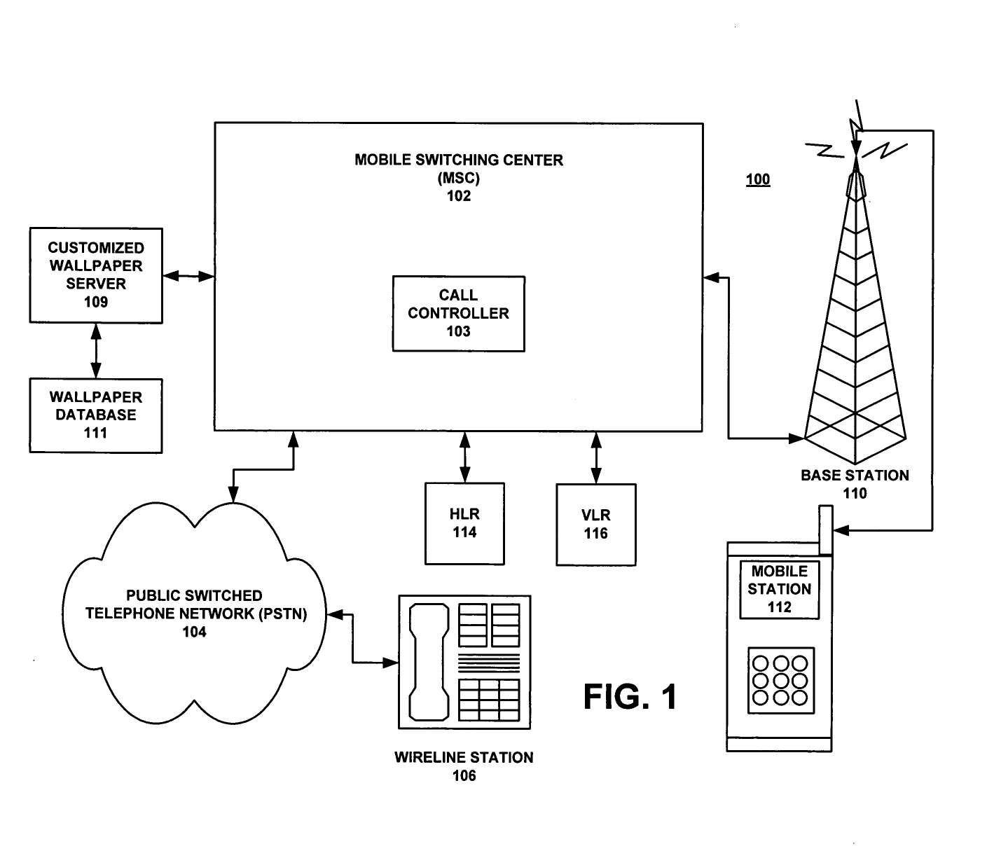

FIG. 1 is a representation of one implementation of an apparatus that provides a customized wallpaper to be displayed on a called party's mobile phone for incoming callers.

Referring to FIG. 1, a network 100 is depicted for at least one mobile terminal 112 of a plurality of mobile terminals operatively connected to a communication network. Although the present system and method may be used with any type of network (wired and wireless, for example), the subscriber may typically be a mobile subscriber who uses a mobile terminal 112 (also referred to as mobile phone, a cell phone, mobile handset, or car phone). The network (or telecommunication network) 100 may have a mobile switching center (MSC) 102, which may have a call controller 103. The network 100 may be, or may be part of, one or more of a telephone network, a local area network (“LAN”), the Internet, and a wireless network. In the depicted embodiment, a public switched telephone network (PSTN) 104 is operatively coupled to the MSC 102. The PSTN 104 routes calls to and from mobile users through the MSC 102. The PSTN 104 also routes calls from and to wireline stations 106. The MSC 102 may also be connected to one or more base stations (BS) 110. Each of the base stations 110 communicates with mobile terminal(s) 112 in its service area. The PSTN 104 generally can be implemented as the worldwide voice telephone network accessible to all those with telephones and access privileges (e.g., AT&T long distance network).

The mobile terminal 112 may have a home location register (HLR) 114 where data about the mobile terminal 112 resides. If the mobile terminal 112 is remotely located from the home location, a visiting location register (VLR) 116 is set up locally for the mobile terminal 112 that is visiting in its service area. HLR 114 can be implemented as a permanent SS7 database utilized in cellular networks, such as, but not limited to, for example, AMPS (Advanced Mobile Phone System), and GSM (Global System for Mobile Communications).

HLR 114 may be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, may be implemented as a local database maintained by the cellular provider whose territory is being roamed. Mobile terminal 112 may be implemented as a cellular device, personal communication device, short message service device or wireless communications device (e.g., a wireless personal digital assistant).

The MSC 102 may have operatively coupled thereto, or alternatively contained therein, a customized wallpaper server 109. The customized wallpaper server 109 may also be operatively coupled to a wallpaper database 111. The wallpaper database 111 may contain a plurality of customized wallpapers with respective corresponding temporary location directory numbers that are stored in the wallpaper database, and at least one default wallpaper for use with temporary location directory numbers not contained in the wallpaper database. The default wallpaper may be associated with at least one of a prefix of a telephone number of an incoming call, and an area code of a telephone number of an incoming call. A respective stored wallpaper may be one of a user created wallpaper, an image downloaded from the Internet, or a predefined wallpaper.

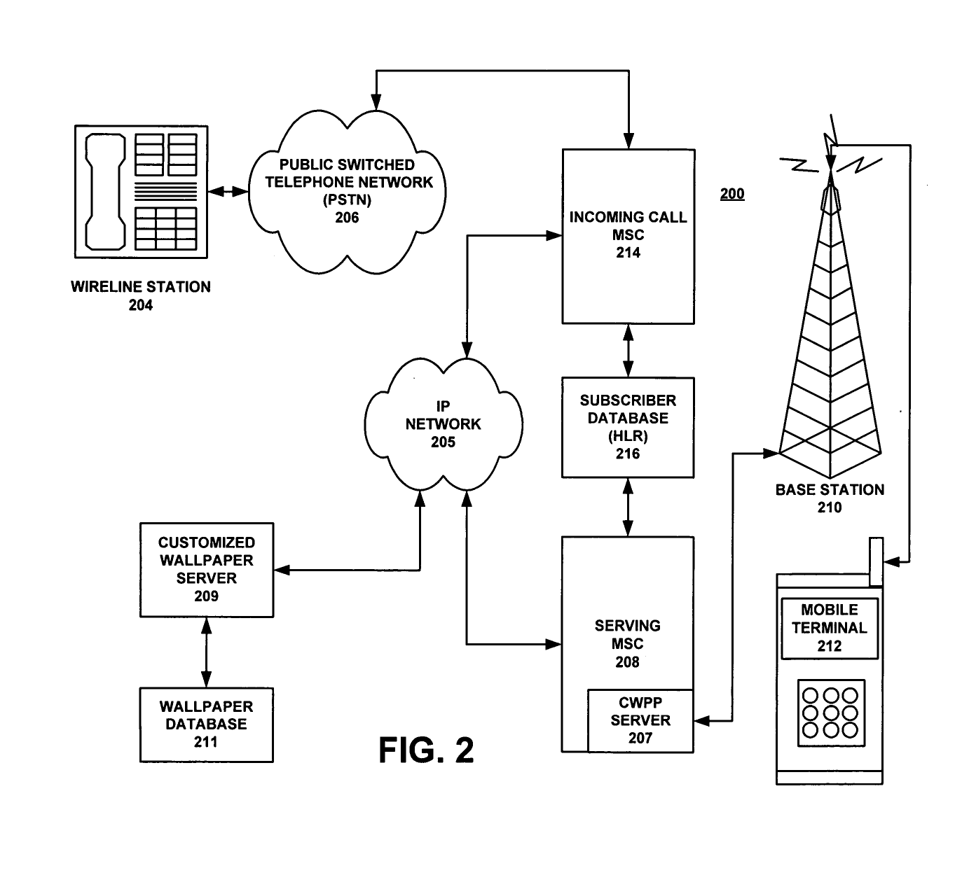

FIG. 2 is a representation of another implementation of an apparatus that provides a customized wallpaper to be displayed on a called party's mobile phone for incoming callers.

Referring to FIG. 2, a network 200 is depicted for at least one mobile terminal 212 of a plurality of mobile terminals operatively connected to a communication network. The network (or telecommunication network) 200 may have an incoming call mobile switching center 214 and a serving mobile switching center 208. In the depicted embodiment, a public switched telephone network (PSTN) 206 is operatively coupled to the incoming call mobile switching center 214. The PSTN 206 may route calls from and to wireline station 204. The serving mobile switching center 208 may be connected to one or more base stations (BS) 210. Each of the base stations 210 communicates with mobile terminal(s) 212 in its service area.

The mobile terminal 212 may have a home location register (HLR) 216 where data about the mobile terminal 212 resides. The HLR 216 may be operatively coupled to the incoming call mobile switching center 214 and the serving mobile switching center 208.

The incoming call mobile switching center 214 and the serving mobile switching center 208 may be operatively coupled to a customized wallpaper server 209, for example, by an IP (Internet Protocol) network 205. The customized wallpaper server 209 may also be operatively coupled to a wallpaper database 211. Furthermore, the serving mobile switching center 208 may have a customized wallpaper processor server 207 that processes a respective wallpaper for display on a display of the mobile terminal 212.

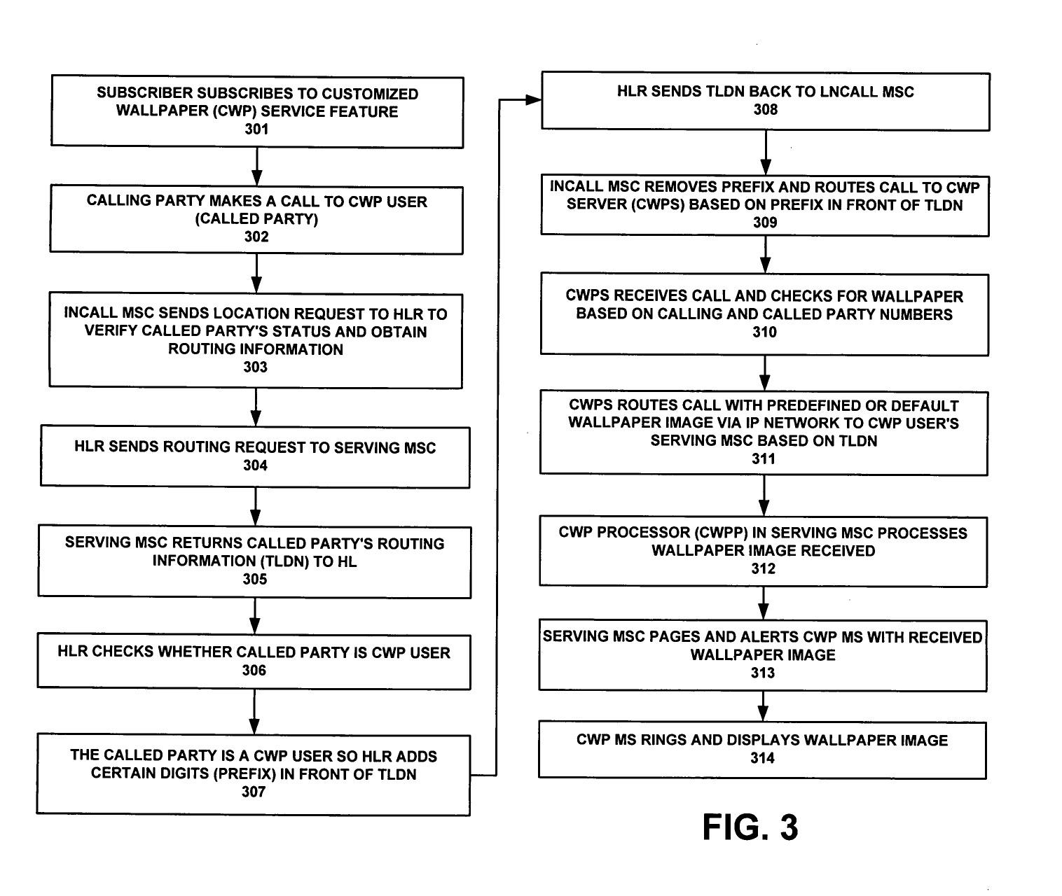

FIG. 3 is a representation of one exemplary flow diagram according to the present method. In this embodiment of the present method, the method may have the following steps: Subscriber subscribes To Customized Wallpaper (CWP) Service Feature, step 301; Calling Party makes a call To CWP user (called party), step 302; Incoming call MSC sends location Request to HLR to verify Called party's status and Obtain routing information, step 303; HLR sends routing request To Serving MSC, step 304; Serving MSC returns Called party's routing Information (TLDN) to HL, step 305; HLR checks whether called party is CWP user, step 306; The called party is a CWP User so HLR adds certain Digits (prefix) in front of TLDN, step 307; HLR sends TLDN back to Incoming call MSC, step 308; Incoming call MSC removes prefix and routes call to CWP server (CWPS) based on prefix in front of TLDN, step 309; CWPS receives call and checks For wallpaper based on calling And called party numbers, step 310; CWPS routes call with predefined or default wallpaper image via IP network to CWP user's Serving MSC based on TLDN, step 311; CWP Processor (CWPP) in Serving MSC processes Wallpaper image received, step 312; Serving MSC pages and Alerts CWP MS with Received wallpaper image, step 313; and CWP MS rings and displays Wallpaper image, step 314.

In another embodiment of the present method, the method may comprise: an incoming call arriving to an incoming call mobile switching center; the incoming call mobile switching center sending a location request query message to a home location register to obtain routing information; if a mobile terminal has subscribed to service, the home location register sending a request to a serving mobile switching center for status, location and routing information of the mobile terminal; the serving mobile switching center sending back the routing information of the mobile terminal, and a temporary location directory number to the home location register; the home location register checking whether the mobile terminal has customized wallpaper service; if the mobile terminal has customized wallpaper service, the home location register adding a prefix to the routing information (temporary location directory number) of the customized wallpaper server and sending the prefix+temporary location directory number and calling party number to the incoming call mobile switching center; the incoming call mobile switching center receiving the routing information from the home location register, removing the prefix, and routing the call to the customized wallpaper server based on the prefix with calling party number, original called party number and temporary location directory number passed to the customized wallpaper server; the customized wallpaper server recognizing that the incoming call is for a customized wallpaper user and checking a database for the customized wallpaper user with the calling party number; the customized wallpaper server identifying which predefined wallpaper is to be displayed and routing the call to the customized wallpaper user's serving mobile switching center, the identified predefined wallpaper image based on the temporary location directory number; a customized wallpaper processor in the serving mobile switching center receiving and processing the identified predefined wallpaper image; the serving mobile switching center paging and alerting the mobile terminal with received wallpaper image; and the mobile terminal displaying the wallpaper image.

In a further embodiment of the present method, the method may comprise: an incoming call arriving to an incoming call mobile switching center; the incoming call mobile switching center sending a location request query message to a home location register to obtain routing information; if a mobile terminal has subscribed to service, the home location register sending a request to a serving mobile switching center for status, location and routing information of the mobile terminal; the serving mobile switching center sending back the routing information of the mobile terminal, and a temporary location directory number to the home location register; the home location register checking whether the mobile terminal has customized wallpaper service; if the mobile terminal has customized wallpaper service, the home location register adding a prefix to the routing information (temporary location directory number) of the customized wallpaper server and sending the prefix+temporary location directory number and calling party number to the in-call mobile switching center; the incoming call mobile switching center receiving the routing information from the home location register, removing the prefix, and routing the call to the customized wallpaper server based on the prefix with calling party number, original called party number and temporary location directory number passed to the customized wallpaper server; the customized wallpaper server recognizing that the incoming call is for a customized wallpaper user and checking a database for the customized wallpaper user with the calling party number; if the customized wallpaper server not finding customized wallpaper associated with the calling party number because the calling party number is not provisioned in the database, the customized wallpaper server providing default wallpaper based on a parameter of the incoming call; the customized wallpaper server routing the call to the serving mobile switching center with a default wallpaper based on the temporary location directory number; and the mobile terminal displaying the default wallpaper image.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
an incoming call mobile switching center that receives incoming calls;
a home location register that stores routing information;
a serving mobile switching center that stores mobile subscriber status, location, and routing information and that supplies a temporary location directory number, the home location register operatively coupled to the incoming call mobile switching center and to the serving mobile switching center;
a customized wallpaper server operatively coupled to a wallpaper database, the wallpaper database having a plurality of stored wallpapers with corresponding assigned temporary location directory numbers, the customized wallpaper server operatively coupled to the incoming call mobile switching center and to the serving mobile switching center; and
a customized wallpaper processor in the serving mobile switching center, the customized wallpaper processor processing a respective wallpaper for display on a display of a mobile terminal;
wherein a respective wallpaper is displayed on a display of a mobile terminal when a respective temporary location directory number is rung at the mobile terminal.

2. The apparatus according to claim 1, wherein the apparatus further comprises a plurality of customized wallpapers with respective corresponding temporary location directory numbers that are stored in the wallpaper database, and at least one default wallpaper for use with temporary location directory numbers not contained in the wallpaper database.

3. The apparatus according to claim 2, wherein the default wallpaper is associated with at least one of a prefix of a telephone number of an incoming call, and an area code of a telephone number of an incoming call.

4. The apparatus according to claim 2, wherein a respective stored wallpaper is one of a user created wallpaper, an image downloaded from the Internet, or a predefined wallpaper.

5. The apparatus according to claim 1, wherein the customized wallpaper server is operatively coupled to the incoming call mobile switching center and to the serving mobile switching center via an IP (Internet Protocol) network.

6. An apparatus, comprising:
a mobile switching center system that receives incoming calls and that supplies a temporary location directory numbers;
a home location register that stores routing information the home location register operatively coupled to the mobile switching center system;
a customized wallpaper server operatively coupled to a wallpaper database, the wallpaper database having a plurality of stored wallpapers with corresponding assigned temporary location directory numbers, the customized wallpaper server operatively coupled to the mobile switching center system; and
a customized wallpaper processor in the mobile switching center system, the customized wallpaper processor processing a respective wallpaper for display on a display of a mobile terminal;
wherein a respective wallpaper is displayed on a display of a mobile terminal when a respective temporary location directory number is rung at the mobile terminal.

7. The apparatus according to claim 6, wherein the mobile switching center system further comprises:
an incoming call mobile switching center that receives incoming calls; and
a serving mobile switching center that stores mobile subscriber status, location, and routing information and that supplies a temporary location directory number, the home location register operatively coupled to the incoming call mobile switching center and to the serving mobile switching center;

8. The apparatus according to claim 6, wherein the apparatus further comprises a plurality of customized wallpapers with respective corresponding temporary location directory numbers that are stored in the wallpaper database, and at least one default wallpaper for use with temporary location directory numbers not contained in the wallpaper database.

9. The apparatus according to claim 8, wherein the default wallpaper is associated with at least one of a prefix of a telephone number of an incoming call, and an area code of a telephone number of an incoming call.

10. The apparatus according to claim 6, wherein a respective stored wallpaper is one of a user created wallpaper, an image downloaded from the Internet, or a predefined wallpaper.

11. The apparatus according to claim 6, wherein the customized wallpaper server is operatively coupled to the incoming call mobile switching center and to the serving mobile switching center via an IP (Internet Protocol) network.

12. A method, comprising:
an incoming call arriving to an incoming call mobile switching center;
the incoming call mobile switching center sending a location request query message to a home location register to obtain routing information;
if a mobile terminal has subscribed to service, the home location register sending a request to a serving mobile switching center for status, location and routing information of the mobile terminal;
the serving mobile switching center sending back the routing information of the mobile terminal, and a temporary location directory number to the home location register;
the home location register checking whether the mobile terminal has customized wallpaper service;
if the mobile terminal has customized wallpaper service, the home location register adding a prefix to the routing information (temporary location directory number) of the customized wallpaper server and sending the prefix+temporary location directory number and calling party number to the in-call mobile switching center;
the incoming call mobile switching center receiving the routing information from the home location register, removing the prefix, and routing the call to the customized wallpaper server based on the prefix with calling party number, original called party number and temporary location directory number passed to the customized wallpaper server;
the customized wallpaper server recognizing that the incoming call is for a customized wallpaper user and checking a database for the customized wallpaper user with the calling party number;
the customized wallpaper server identifying which predefined wallpaper is to be displayed and routing the call to the customized wallpaper user's serving mobile switching center, the identified predefined wallpaper image based on the temporary location directory number;
a customized wallpaper processor in the serving mobile switching center receiving and processing the identified predefined wallpaper image;
the serving mobile switching center paging and alerting the mobile terminal with received wallpaper image; and
the mobile terminal displaying the wallpaper image.

13. The method according to claim 12, wherein the method further comprises storing a plurality of customized wallpapers with respective corresponding temporary location directory numbers in the wallpaper database.

14. The apparatus according to claim 12, wherein a respective stored wallpaper is one of a user created wallpaper, an image downloaded from the Internet, or a predefined wallpaper.

15. The apparatus according to claim 12, wherein the customized wallpaper server is operatively coupled to the incoming call mobile switching center and to the serving mobile switching center via an IP (Internet Protocol) network.

16. A method, comprising:
an incoming call arriving to an incoming call mobile switching center;
the incoming call mobile switching center sending a location request query message to a home location register to obtain routing information;
if a mobile terminal has subscribed to service, the home location register sending a request to a serving mobile switching center for status, location and routing information of the mobile terminal;
the serving mobile switching center sending back the routing information of the mobile terminal, and a temporary location directory number to the home location register;
the home location register checking whether the mobile terminal has customized wallpaper service;
if the mobile terminal has customized wallpaper service, the home location register adding a prefix to the routing information (temporary location directory number) of the customized wallpaper server and sending the prefix+temporary location directory number and calling party number to the in-call mobile switching center;
the incoming call mobile switching center receiving the routing information from the home location register, removing the prefix, and routing the call to the customized wallpaper server based on the prefix with calling party number, original called party number and temporary location directory number passed to the customized wallpaper server;
the customized wallpaper server recognizing that the incoming call is for a customized wallpaper user and checking a database for the customized wallpaper user with the calling party number;
if the customized wallpaper server not finding customized wallpaper associated with the calling party number because the calling party number is not provisioned in the database, the customized wallpaper server providing default wallpaper based on a parameter of the incoming call;
the customized wallpaper server routing the call to the serving mobile switching center with a default wallpaper based on the temporary location directory number; and
the mobile terminal displaying the default wallpaper image.

17. The method according to claim 16, wherein the method further comprises storing a plurality of customized wallpapers with respective corresponding temporary location directory numbers in the wallpaper database, and storing at least one default wallpaper for use with temporary location directory numbers not contained in the wallpaper database.

18. The apparatus according to claim 16, wherein a respective stored wallpaper is one of a user created wallpaper, an image downloaded from the Internet, or a predefined wallpaper.

19. The apparatus according to claim 16, wherein the customized wallpaper server is operatively coupled to the incoming call mobile switching center and to the serving mobile switching center via an IP (Internet Protocol) network.

20. The apparatus according to claim 16, wherein the parameter of the incoming call is at least one of a prefix of a telephone number of the incoming call, and an area code of a telephone number of the incoming call.
